(19) United States
(12) Patent Application Publication
(10) Pub. No.: US 2021/0039204 A1
(43) Pub. Date: Feb. 11, 2021

(54) METHOD FOR OPTIMIZED STRUCTURING OF A 2D CODE ON A COMPONENT

(71) Applicant: II-VI Delaware, Inc., Wilmington (DE)

(72) Inventors: Nico Baumbach, Kleinmachnow (DE); Alexander Müller, Kleinmachnow (DE)

(21) Appl. No.: 16/550,768

(22) Filed: Aug. 26, 2019

(30) Foreign Application Priority Data
Aug. 9, 2019 (DE) 10 2019 121 527.7

(51) Int. Cl. B23K 26/364; B23K 26/064

(52) U.S. Cl. CPC B23K 26/364; B23K 26/064

(57) ABSTRACT

An apparatus and a method for producing a mark on a workpiece. The method comprises the steps of positioning a laser material processing optics on a workpiece; applying laser radiation to the surface of the workpiece; producing a material elevation on the surface of the workpiece and generating a plurality of material elevations by repeating the aforementioned steps.

### CROSS-REFERENCE TO RELATED APPLICATIONS

The present application claims priority of German Patent Application No. DE 10 2019 121 527.7 filed on Aug. 9, 2019. The aforementioned application is hereby incorporated by reference in its entirety.

### BACKGROUND OF THE INVENTION

### Field of the Invention

The invention relates to an apparatus and a method for producing a mark on a workpiece or component.

### Brief Description of the Related Art

In laser material processing of metals, for component tracking purposes, parts are often labeled with 2D labels or marks in the form of different codes, e.g. DM or QR codes (Data Matrix, Quick Response). These can be executed both statically (same information) and dynamically (changing information, possibly based on external signals).

Marking laser or dot-matrix printers are frequently used on metallic components. In this case, marking lasers either slightly reduce the material of a surface area or change the microstructure of the material via the energy input and thus generate a corresponding contrast.

These markers may then be read out by scanners and/or cameras as long as there are no further process steps of the part which render the mark unreadable, e.g. a painting process.

A problem with previously known solutions from the prior art is that the mark of machined components is done separately by means of the already mentioned marking laser or dot matrix printer. This is disadvantageous in terms of process times, since the workpieces must be moved to a separate station for marking.

### SUMMARY OF THE INVENTION

The object of the present invention is therefore to carry out the process step of the component mark within a standard laser cell, so that no separate marking station must be provided.

The present invention provides a method of producing a mark on a component, comprising the steps of:

a. Positioning optics for laser material processing on a component;

b. Applying laser radiation to the surface of the component;

c. Generating a material elevation on the surface of the component;

d. Generating a variety of material elevations by repeating steps a-c.

In a further aspect, the method comprises the step that the duration of the application of the laser beam may last at least for 1 ms.

Furthermore, it is provided that the duration of the application of the laser beam last at least for 2 ms.

The method according to the invention may comprise in a further embodiment, that the generation of the plurality of material elevations can be done in a previously defined grid of points, wherein further in the previously defined grid of points, points located adjacent to a generated material elevation are skipped.

With regard to the skipping, it can be provided that in a line-by-line axis of the previously defined grid of points, two adjacent points located to a generated material elevation will be skipped.

Furthermore, it is provided in a further aspect of the method according to the invention that in the previously defined grid of points, two diagonally adjacent points located next to a generated material, elevations can be skipped.

The method according to the invention can furthermore produce a material elevation with a height of at least 20 μm.

In a further embodiment of the invention, the step of positioning the optics for laser material processing on the workpiece may take at least 4 ms after the generation of the first material elevation.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### BRIEF DESCRIPTION OF THE FIGURES

The invention will be described based on figures. It will be understood that the embodiments and aspects of the invention described in the figures are only examples and do not limit the protective scope of the claims in any way. The invention is defined by the claims and their equivalents. It will be understood that features of one aspect or embodiment of the invention can be combined with a feature of a different aspect or aspects of other embodiments of the invention, in which:

FIG. 1 shows elevations on the material surface resulting from the application of the method according to the invention.

FIG. 2 shows a microscope image of a part of a structured component after applying the method according to the present invention.

### DETAILED DESCRIPTION OF THE INVENTION

The object of the invention is achieved by the features of the independent claims. Further embodiments are claimed in the dependent claims.

The terms “component” and “workpiece” shall be understood synonymously as they refer to the part which will be processed by a laser material processing head.

The invention provides a device which makes it possible, depending on the kind of material, thickness of the material, surface properties and laser spot size to carry out a process in which the laser does not remove material but throws it up, thus shaping it comparable to a mountain. These mountains are similar to a elevation comparable to the execution of Braille.

According to the invention, the throwing up of material is achieved in that the laser remains longer at a point at which a mark is to be generated.

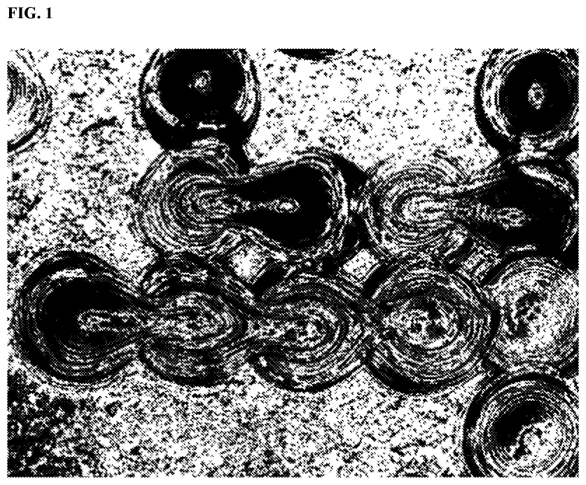

FIG. 1 shows the result of the generation of individual marks, which were created by applying 1 ms “laser-on” time at the respective points and then jumping within 2 ms to the next point, where that point was generated by applying again additional laser time (laser on).

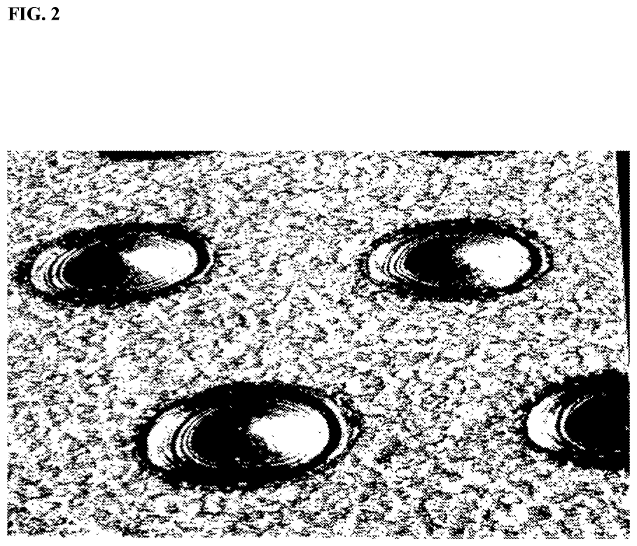

Elevations as shown in FIG. 1 could be brought to about 40 μm height (referring to the component surface) in experiments (comp. FIG. 2). A cathodic dip coating builds up a layer thickness of approx. 15 μm on the component. Thus, the elevations, which are generated according to the invention should also be visible after painting. However, since purely contrast-based evaluations no longer function due to the applied coating, a camera-based evaluation with additional component illumination is proposed in connection with the present invention.

Yet, FIG. 1 also shows that thermal optimization of the codes may become necessary. Tarnish colors are negligible in a later coating, but it can lead to a “merging” of several adjacent points, as shown in FIG. 1. A merge of points leads to the fact that no sharp contours of the individual points will exist anymore and there is no clear separation between “mountain and valley”. This makes subsequent detection of marks difficult or even impossible.

This can be prevented in several ways. On the one hand, the jump time between the individual points can be increased. Already 5 ms are enough to ensure a clear separation of the points. However, this also doubles the process time, which is why this solution is not preferred. A better solution seems to be optimizing the path on which the scanner travels the individual points. It is conceivable to provide a logic that decides whether the next point in the code to be written directly adjoins the previous grid point and this will be initially skipped. Thus, a jump distance of at least 2× “Dot Spacing” in horizontal as well as vertical direction is enforced. In addition, a “3×3-Dot large exclusion mask” ensures that there are no direct diagonal contact points.

Other embodiments of the jump variation, for example. 3× “Dot Spacing” are also conceivable. Furthermore, the consideration applies both in rows and line-by-line. In addition, individual spots could also be qualitatively evaluated by means of a high-speed infrared camera.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method of producing a mark on a component, comprising the steps of:
a. positioning optics for laser material processing on a component;
b. applying laser radiation to the surface of the component;
c. generating a material elevation on the surface of the component; and
d. generating a variety of material elevations by repeating steps a-c.

2. The method of claim 1, wherein the duration of the application of the laser beam lasts at least for 1 ms.

3. The method of claim 1, wherein the duration of the application of the laser beam lasts at least for 1 ms.

4. The method of claim 1, comprising the generation of a plurality of material elevations that takes place in a previously defined grid of points.

5. The method of claim 4, wherein in the previously defined grid of points, points located adjacent to a generated material elevation are skipped.

6. The method of claim 4, wherein in a line-by-line axis of the previously defined grid of points, two adjacent points located next to a generated elevation are skipped.

7. The method of claim 4, wherein in a diagonal axis of the previously defined grid of points, two adjacent points located next to a generated elevation are skipped.

8. The method of claim 1, wherein material elevations with a height of at least 20 mm are generated.

9. The method of claim 1, wherein the positioning of the optics for laser material processing on the component takes at least 4 ms after the generation of the first material elevation.
